(19) United States
(12) Patent Application Publication
(10) Pub. No.: US 2018/0166758 A1
(43) Pub. Date: Jun. 14, 2018

(54) VEHICLE BATTERY THERMOELECTRIC MODULE WITH IMPROVED HEAT TRANSFER AND THERMAL ISOLATION FEATURES

(71) Applicant: Gentherm Inc., Northville, MI (US)

(72) Inventor: David Scott Thomas, Royal Oak, MI (US)

(21) Appl. No.: 15/580,483

(22) PCT Filed: Jun. 8, 2016
(86) PCT No.: PCT/US2016/036400

§ 371 Date: Dec. 7, 2017

Related U.S. Application Data
(60) Provisional application No. 62/173,449, filed on Jun. 10, 2015.

(51) Int. Cl. H01M 10/6572; H01M 10/0525; H01M 10/613; H01M 10/625; F28D 15/00

(52) U.S. Cl. CPC H01M 10/6572; H01M 10/0525; F28F 2013/001; H01M 10/625; F28D 15/00; H01M 10/613

(57) ABSTRACT

A cooling system for thermally conditioning a component includes a heat spreader configured to provide a cold side. An insulator plate is arranged adjacent to the heat spreader. A thermoelectric device is arranged within the insulator plate and operatively thermally exposed on a side of the insulator plate opposite the heat spreader. A cold plate assembly is arranged adjacent to the insulator plate and operatively engages the thermoelectric device.

### CROSS-REFERENCE TO RELATED APPLICATIONS

This application claims priority to U.S. Provisional Application No. 62/173,449, which was filed on Jun. 10, 2015 and is incorporated herein by reference.

### BACKGROUND

This disclosure relates to a thermoelectric module used to cool a vehicle component, such as a battery. In particular, the disclosure relates to heat transfer and thermal isolation features within the thermoelectric module to improve heat transfer efficiency.

Lithium ion batteries are used in passenger and other types of vehicles to provide power to electric motors that provide propulsion to the vehicle. Such batteries can generate a significant amount of heat such that the battery must be cooled to prevent performance degradation.

One type of vehicle battery cooling arrangement that has been proposed that includes a thermoelectric module arranged beneath the battery and adjacent to a cold plate assembly. The thermoelectric module includes thermoelectric devices that operate based upon the Peltier effect to provide cooling adjacent to the battery. Heat transferred through the thermoelectric device is rejected to the cold plate assembly, which may have a cooling fluid circulated therethrough and sent to a heat exchanger.

It is desirable to design the thermoelectric module so as to efficiently transfer heat through some components within the thermoelectric module while insulating other components within the thermoelectric module.

### SUMMARY

In one exemplary embodiment, a cooling system for thermally conditioning a component includes a heat spreader configured to provide a cold side. An insulator plate is arranged adjacent to the heat spreader. A thermoelectric device is arranged within the insulator plate and operatively thermally exposed on a side of the insulator plate opposite the heat spreader. A cold plate assembly is arranged adjacent to the insulator plate and operatively engages the thermoelectric device.

In a further embodiment of the above, a first fastening element secures the heat spreader to the insulator plate. The heat spreader, the insulator plate and the thermoelectric device provide a thermoelectric module assembly.

In a further embodiment of any of the above, the heat spreader includes a raised pad that operatively engages the thermoelectric device.

In a further embodiment of any of the above, a thermal foil is arranged between and in engagement with the pad and the thermoelectric device.

In a further embodiment of any of the above, a heat transfer insert is provided between and operatively in engagement with the cold plate assembly and the thermoelectric device on the side opposite the heat spreader.

In a further embodiment of any of the above, the heat transfer insert is a discrete element from the insulator plate and the cold plate assembly.

In a further embodiment of any of the above, the heat transfer insert is captured by the insulator plate and retained in fixed position between the heat spreader and the cold plate assembly.

In a further embodiment of any of the above, a thermal foil is arranged between and in engagement with the cold plate assembly and the thermoelectric device.

In a further embodiment of any of the above, the cold plate assembly includes cooling passages that are configured to receive a coolant circulated through the cooling passages. A second fastening element secures the insulator plate to the cold plate assembly.

In another exemplary embodiment, a thermoelectric module assembly for thermally conditioning a component. The assembly includes a heat spreader that is configured to provide a cold side. An insulator plate is arranged adjacent to the heat spreader. A thermoelectric device is arranged within the insulator plate. A heat transfer insert is captured by the insulator plate and retained in fixed position relative to the heat spreader. The heat transfer insert is operatively thermally exposed on a side of the insulator plate opposite the heat spreader.

In a further embodiment of any of the above, the heat transfer insert is a discrete element from the insulator plate. The insulator plate is plastic and the heat transfer insert is plastic.

In a further embodiment of any of the above, the insulator plate includes an aperture. The thermoelectric device and the heat transfer insert are arranged within the aperture.

In a further embodiment of any of the above, the heat transfer insert includes a flange embedded in the insulator plate.

In a further embodiment of any of the above, the heat spreader includes a raised pad operatively engaging the thermoelectric device.

In a further embodiment of any of the above, a fastening element clamps the pad operatively into engagement with the thermoelectric device.

In a further embodiment of any of the above, a thermal foil is arranged between and in engagement with the pad and the thermoelectric device.

In one exemplary embodiment, a thermoelectric module assembly for thermally conditioning a component includes a heat spreader that is configured to provide a cold side. The heat spreader is a graphite material. An insulator plate is arranged adjacent to the heat spreader. A thermoelectric device is arranged within the insulator plate and operatively engages the heat spreader.

In a further embodiment of any of the above, the heat spreader is a second heat spreader and comprises a first heat spreader on a side of the insulator plate opposite the second heat spreader. The first heat spreader is metallic and comprises a cold plate assembly that engages the second heat spreader.

In a further embodiment of any of the above, the insulator plate is plastic and includes a foam material arranged between and in engagement with the first heat spreader and the insulator plate.

In a further embodiment of any of the above, the heat spreader has a through-plane thermal conductivity in a range of 3-15 W/m·K, and an in-plane thermal conductivity in a range of 100-1500 W/m·K.

### BRIEF DESCRIPTION OF THE DRAWINGS

The disclosure can be further understood by reference to the following detailed description when considered in connection with the accompanying drawings wherein:

FIG. 1A is a highly schematic view of a vehicle with a vehicle system temperature regulated by a cooling system.

FIG. 1B illustrates a cooling system that includes a thermoelectric module assembly and a cold plate assembly.

FIG. 2 is a perspective view of the thermoelectric module assembly mounted to the cold plate assembly.

FIG. 3 is an exploded perspective view of the thermoelectric module assembly.

FIG. 4 is a to elevational view of the insulator plate with thermoelectric devices arranged within the insulator plate.

FIG. 5A is a cross-sectional view through the thermoelectric module assembly shown in FIG. 2 and taken along line 5A-5A.

FIG. 5B is an enlarged cross-sectional view of a portion of a thermoelectric module assembly illustrated in FIG. 5A and shown as area 5B.

FIG. 6 is an exploded perspective view of another thermoelectric module assembly.

FIG. 7 is a cross-sectional view of the thermoelectric module assembly shown in FIG. 6 and mounted in a stack to a vehicle battery, cold plate assembly and DC/DC converter.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

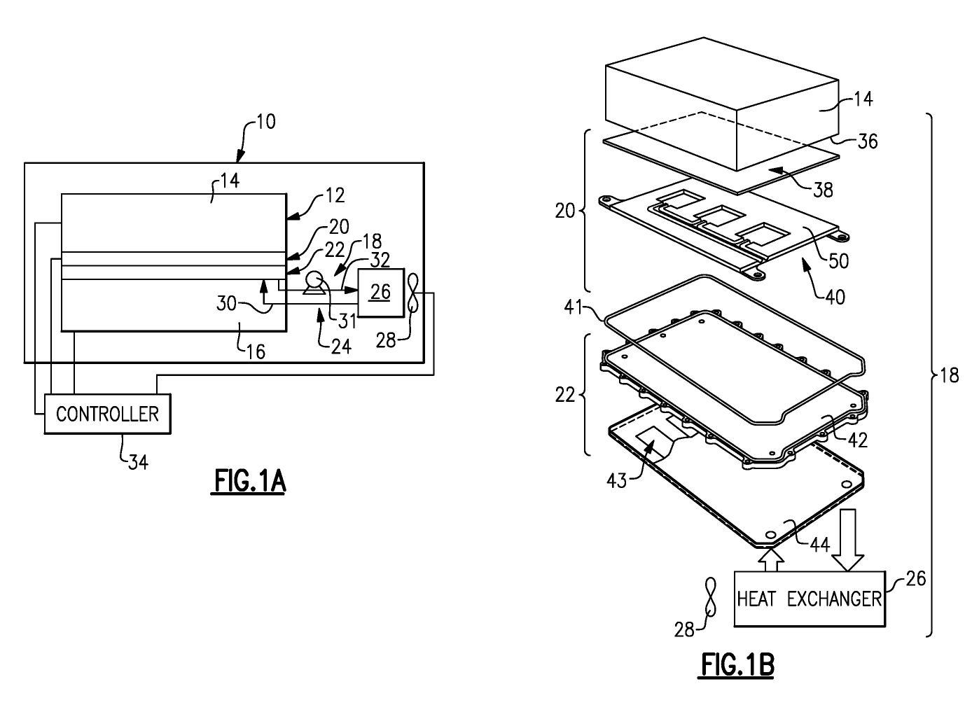

A vehicle 10 is schematically illustrated in FIG. 1A. The vehicle 10 includes a vehicle system 12 that either needs to be heated or cooled. In one example, the vehicle system 12 includes a battery 14, such as a lithium ion battery used for vehicle propulsion that generates a significant amount of heat. Such a battery must be cooled during operation otherwise the battery efficiency and/or integrity may degrade.

A cooling system 18 is arranged between the battery 14 and a DC/DC converter 16 in a stack to remove heat from the battery 14 thus cooling the vehicle system 12. The DC/DC converter 16 provides an electrical interface between the battery 14 and the vehicle electrics. A cooling system 18 includes a thermoelectric module assembly 20 mounted to a cold plate assembly 22 that is in communication with a cooling loop 24. A cooling fluid, such as glycol, is circulated by a pump 31 within the cooling loop 24. Heat is rejected to the coolant via the cold plate assembly 22 through supply and return coolant lines 30, 32 that are connected to a heat exchanger 26. A fan or blower 28 may be used to remove heat from the coolant within the heat exchanger 26 to an ambient environment, for example.

A controller 34 communicates with various components of the vehicle 10, vehicle system 12 and cooling system 18 to coordinate battery cooling. Sensors and outputs (not shown) may be connected to the controller 34.

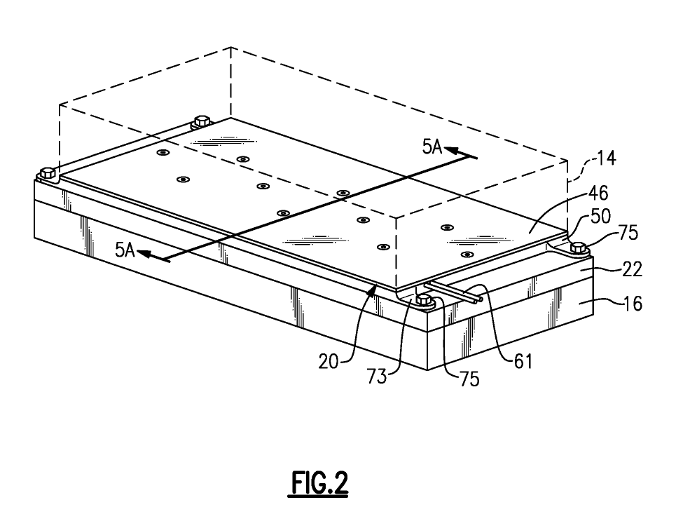

An example cooling system 18 is shown in more detail in FIG. 1B. The thermoelectric module assembly 20 includes a cold side 38 that supports a surface 36 of the battery 14. An insulator plate 50 carries thermoelectric devices (shown at 58 in FIG. 2) and separates the cold side 38 (at the battery 14) from a hot side 40 (at the cold plate assembly 22).

The cold plate assembly 22 includes first and second cold plates 42, 44 secured to one another to enclose a network of fluid passages (shown schematically at 43) that communicate coolant across the cold plate assembly 22 to receive heat rejected from the hot side 40. A seal 41 may be provided between the thermoelectric module assembly 20 and the cold plate assembly 22. The heated coolant is transferred to the heat exchanger 26, which may be located remotely from the stack.

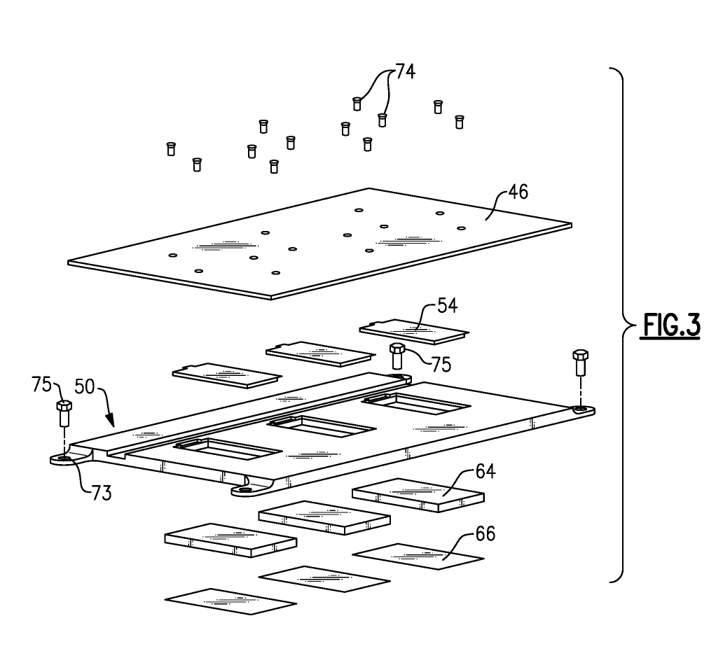

Referring to FIGS. 2-3, an example thermoelectric module assembly 20 is shown in more detail. The cold side 38 is provided by a heat spreader 46, which is constructed from metal, for example. The heat spreader 46 is secured to the insulator plate 50, which is constructed from a plastic, by fasteners 74 to provide a single unit that can be secured to the cold plate assembly 22. Without a metallic bottom heat spreader arranged opposite the heat spreader 46 heat can be transferred more efficiently and directly to the cold plate assembly 22. Attachment features 73 are provided integrally on the insulator plate 50 as ears extending outwardly from an outer perimeter of the insulator plate 50, which are used to secure the thermoelectric module assembly 20 to the cold plate assembly 22 with fasteners 75.

The insulator plate 50 includes apertures 52 within which thermoelectric devices 54 are arranged, as shown in FIG. 3. In the example, the thermoelectric devices 54 utilize the Peltier effect to provide a cold side adjacent to the heat spreader 46 and a hot side operative adjacent to the cold plate assembly 22.

Insulator plate 50 includes formed wire channels 60 that receive wires 61 of the thermoelectric devices 54 of the thermoelectric module assembly 20. In the example, three Peltier devices are wired in series with one another.

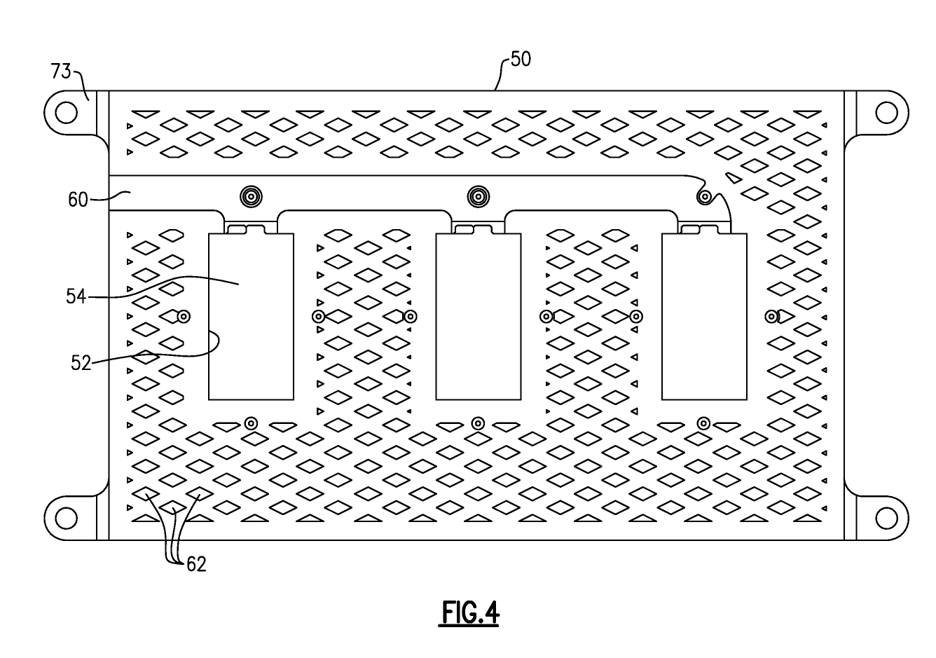

A matrix of voids 62, shown in FIG. 4, is provided in the insulator plate 50 to reduce the thermal mass of the insulator plate 50 and provide air gaps that insulate the heat spreader 46 from the cold plate assembly 22 to ensure that heat is transferred through the thermoelectric devices 54. The voids 62 may be any suitable size, shape or pattern. The voids may be deep recesses relative to the thickness of the insulator plate 50 (shown) or extend all the way through the insulator plate 50.

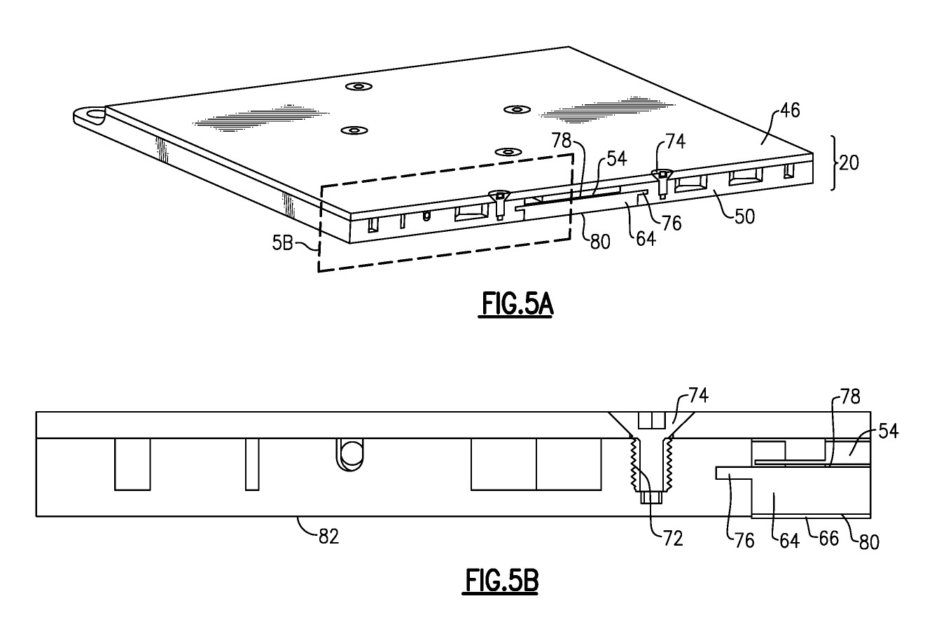

It is desirable to maintain a desired clamp load and engagement between the thermal transfer components of the thermoelectric module assembly 20 and the cold plate assembly 22. Referring to FIGS. 3 and 5A-5B, a thermally conductive pad 64 is a discrete metallic structure provided in the aperture 52 to transfer heat from the thermoelectric device 54 to the cold plate assembly 22. In the example, a flange 76 is provided around the pad 64 and is embedded in the insulator plate 50, for example, by overmolding, to fix the position of the pad 64 relative to the heat spreader 46 and cold plate assembly 22. Other locating features also may be used, and the pads 64 need not be captured by being molded into the insulator plate 50.

The thermoelectric device 54 is supported on a first surface 78 of the pad 64 adjacent to the heat spreader 46. Thermal interface material (not shown) may be provided between the thermoelectric device 54 and the heat spreader 46 to maintain sufficient thermal engagement between these components. A second surface 80 of the pad 64 is near or may extend beyond a surface 82 of the insulator plate 50. In this manner, the thermoelectric device 54 is thermally exposed to the cold plate assembly 22. A thermal foil 66 may be provided on the second surface 80 to ensure adequate engagement between the heat transfer components for thermal efficiency.

In the example, fasteners 74 extend through holes in the heat spreader 46 and are received within threaded inner diameters 72 of the insulator plate 50 to secure the heat spreader 46 and the insulator plate 50, which clamps the thermoelectric devices 54 to the pads 64 embedded in the insulator plate 50. In another example, threads can be placed in the heat spreader and the screws can be put in through the insulation plate. This puts a solid barrier between the screws and the battery cells, reducing the risk of contact. The fasteners 74 are metallic, but since the insulator plate 50 is plastic, thermal losses from the heat spreader 46 to the cold plate assembly 22 via the fasteners 74 are avoided. The fasteners 74 are tightened to a predetermined torque, and the fixation of the pads 64 within the insulator plate 50 limit the travel of the heat spreader 46 relative to insulator plate 50 as the fasteners are torqued.

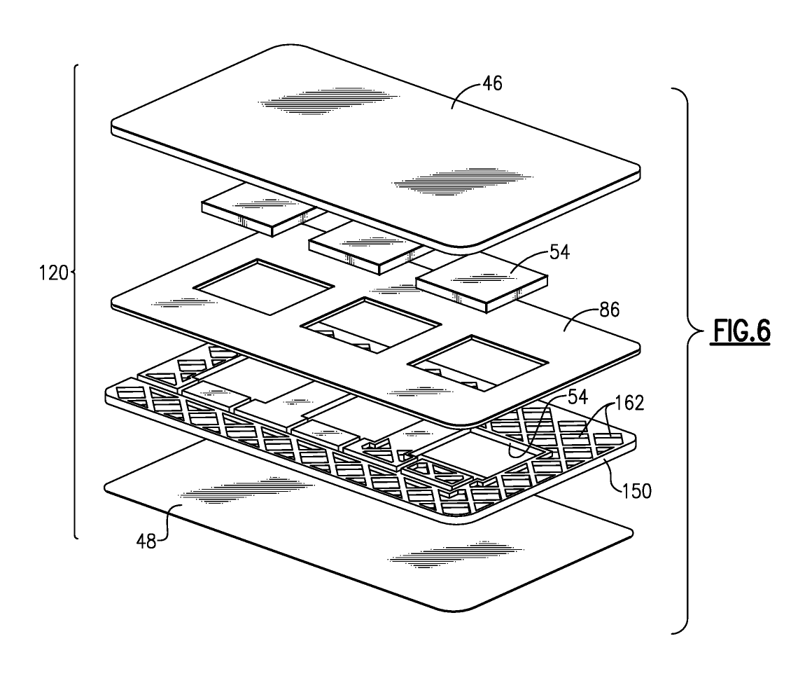

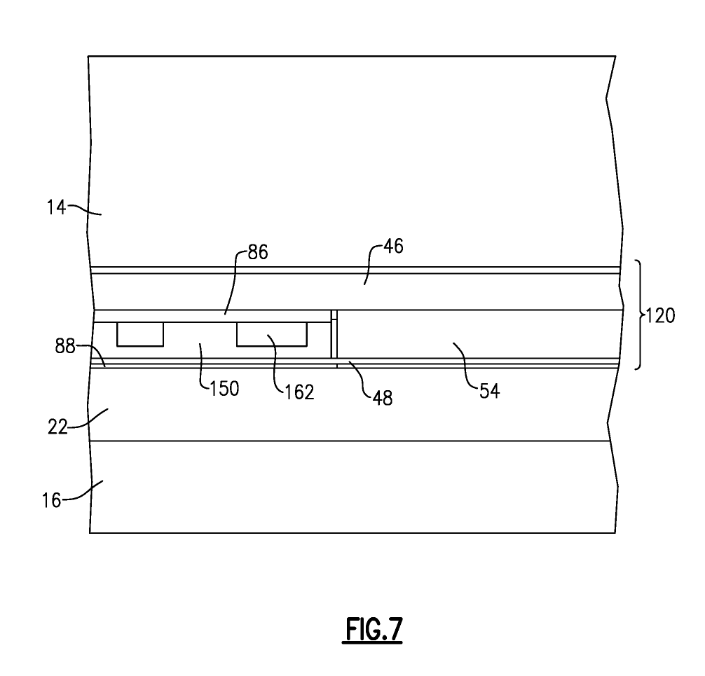

Another example thermoelectric module assembly 120 is shown in FIGS. 6 and 7. In this example, a second heat spreader 48 is supported on the insulator plate 150 on a side opposite the heat spreader 46. Unlike the first heat spreader 46, which is metallic, the second heat spreader 48 is a graphite material layer having a through-plane thermal conductivity in a range of 3-15 W/m·K, and an in-plane thermal conductivity in a range of 100-1500 W/m·K. If desired, either or both heat spreaders may be constructed from graphite.

A thin plastic substrate 88 can be laminated with the graphite layer so that the graphite layer can be handled more easily without damaging the structural integrity of the fragile graphite. If a plastic substrate is used, openings may be provided in the graphite layer to provide a thermal connection between the cold plate assembly 22 and thermoelectric device 54 through the pad 64. As a result, the use of thermal foils may be eliminated.

A foam layer 88 can be used between the insulator plate 150 and the heat spreader 46, in addition to the voids 162, to further thermally isolate the cold plate assembly 22 from the heat spreader 46 to encourage heat transfer through the thermoelectric device 54 only.

In operation, an undesired battery temperature is detected by the controller 34. The thermoelectric devices 50 are powered to produce a cold side of the thermoelectric device 54 that is transferred to the first heat spreader 46 adjacent to the battery 14 increasing the temperature differential between these components and increasing the heat transfer therebetween. Heat from the battery is transferred from the heat spreader 46 through the thermoelectric device 54 directly to the cold plate assembly 22 in the case of the example thermoelectric module assembly 20 shown in FIGS. 2-5. However, the isolator plate 50 acts to prevent heat from being transmitted from the first heat spreader 46 to the second heat spreader 48. For the example thermoelectric module assembly 120 shown in FIGS. 6-7, a graphite layer may be used as a second heat spreader to distribute and enhance the transfer of heat to the cold plate assembly 22. Coolant is circulated from the cold plate assembly 22 to the heat exchanger 26, which rejects heat to the ambient environment, and this heat transfer rate may be increased by use of the blower 28.

It should be understood that although a particular component arrangement is disclosed in the illustrated embodiment, other arrangements will benefit herefrom. Although particular step sequences are shown, described, and claimed, it also should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A cooling system for thermally conditioning a component, the cooling system comprising:
a heat spreader configured to provide a cold side;
an insulator plate arranged adjacent to the heat spreader;
a thermoelectric device arranged within the insulator plate and operatively thermally exposed on a side of the insulator plate opposite the heat spreader; and
a cold plate assembly arranged adjacent to the insulator plate and operatively engaging the thermoelectric device.

2. The cooling system according to claim 1, comprising a first fastening element securing the heat spreader to the insulator plate, wherein the heat spreader, the insulator plate and the thermoelectric device provide a thermoelectric module assembly.

3. The cooling system according to claim 1, wherein the heat spreader includes a raised pad operatively engaging the thermoelectric device.

4. The cooling system according to claim 3, comprising a thermal foil arranged between and in engagement with the pad and the thermoelectric device.

5. The cooling system according to claim 1, comprising a heat transfer insert provided between and operatively in engagement with the cold plate assembly and the thermoelectric device on the side opposite the heat spreader.

6. The cooling system according to claim 5, wherein the heat transfer insert is a discrete element from the insulator plate and the cold plate assembly.

7. The cooling system according to claim 6, wherein the heat transfer insert is captured by the insulator plate and retained in fixed position between the heat spreader and the cold plate assembly.

8. The cooling system according to claim 6, comprising a thermal foil arranged between and in engagement with the cold plate assembly and the thermoelectric device.

9. The cooling system according to claim 1, wherein the cold plate assembly includes cooling passages configured to receive a coolant circulated through the cooling passages, and comprising a second fastening element securing the insulator plate to the cold plate assembly.

10. A thermoelectric module assembly for thermally conditioning a component, the assembly comprising:
a heat spreader configured to provide a cold side;
an insulator plate arranged adjacent to the heat spreader;
a thermoelectric device arranged within the insulator plate; and
a heat transfer insert captured by the insulator plate and retained in fixed position relative to the heat spreader, the heat transfer insert operatively thermally exposed on a side of the insulator plate opposite the heat spreader.

11. The assembly according to claim 10, wherein the heat transfer insert is a discrete element from the insulator plate, the insulator plate is plastic and the heat transfer insert is plastic.

12. The assembly according to claim 10, wherein the insulator plate includes an aperture, the thermoelectric device and the heat transfer insert are arranged within the aperture.

13. The assembly according to claim 12, wherein the heat transfer insert includes a flange embedded in the insulator plate.

14. The assembly according to claim 13, wherein the heat spreader includes a raised pad operatively engaging the thermoelectric device.

15. The assembly according to claim 14, comprising a fastening element clamping the pad operatively into engagement with the thermoelectric device.

16. The assembly according to claim 15, comprising a thermal foil arranged between and in engagement with the pad and the thermoelectric device.

17. A thermoelectric module assembly for thermally conditioning a component, the assembly comprising:
a heat spreader configured to provide a cold side, wherein the heat spreader is a graphite material;
an insulator plate arranged adjacent to the heat spreader; and
a thermoelectric device arranged within the insulator plate and operatively engaging the heat spreader.

18. The assembly according to claim 17, wherein the heat spreader is a second heat spreader, and comprising a first heat spreader on a side of the insulator plate opposite the second heat spreader, the first heat spreader is metallic, and comprising a cold plate assembly engaging the second heat spreader.

19. The assembly according to claim 18, wherein the insulator plate is plastic, and comprising a foam material arranged between and in engagement with the first heat spreader and the insulator plate.

20. The assembly according to claim 17, wherein the heat spreader has a through-plane thermal conductivity in a range of 3-15 W/m·K, and an in-plane thermal conductivity in a range of 100-1500 W/m·K.
